(19) United States
(12) Patent Application Publication
(10) Pub. No.: US 2016/0044380 A1
(43) Pub. Date: Feb. 11, 2016

(54) PERSONAL HELPER BOT SYSTEM

(71) Applicant: Bertrand Barrett, Lawrenceville, GA (US)

(72) Inventor: Bertrand Barrett, Lawrenceville, GA (US)

(21) Appl. No.: 14/736,265

(22) Filed: Jun. 11, 2015

Related U.S. Application Data
(60) Provisional application No. 62/011,552, filed on Jun. 12, 2014.

(51) Int. Cl. H04N 21/482; H04N 21/81; H04N 21/443; H04N 21/466; H04N 21/45

(52) U.S. Cl. CPC H04N 21/4826; H04N 21/4667; H04N 21/4532; H04N 21/4431; H04N 21/812; H04N 21/8173

(57) ABSTRACT

MyBOTS.Tv—the personal helper BOT system utilizes a customizable personal assistant in the form of an avatar to engage its owner in a conversational manner with natural language commands to coordinate activity of a team of autonomous helper BOTs. Among a variety of other tasks, BOTs, which are software applications that run automated tasks over the Internet, collaborate to create the owner's schedule, maintain his/her to-do list, obtain personally interesting information, provide personalized services and searches, perform web site transactions, use all types of web apps, complete tasks and/or synthesize useful products for their owners.

In some embodiments, the helper BOTs system leverages Digital Library (DL) Architectures to house elements that they intelligently serve. The underlying Digital Library Architecture features an induction process that elicits facts about incoming elements that can be judged by a panel of agents. Agents judge elements according to areas of discretion which are of interest to the consumer population. The judgments are then stored as part of each element's metadata. Helper BOTs then deliver the elements intelligently by probabilistically ranking, sorting, classifying, and/or presenting and serving them to users in accordance with value preferences indicated in their profiles. One such embodiment, (which has been previously published as a Virtual Knowledge Architecture for Interactive Television) ranks and serves TV programs to people based on the value preferences set in their profile(s).

In other embodiments, helper BOTs leverage user-directed search paradigms to refine and customize the search function according to the searcher's preferences, style and demographic information. In these embodiments, helper BOTs are directed by way of a search construction wizard to return search results in accordance with searcher profiles and demands such as language, context of content, age of document, and age appropriateness. In this regard, searcher preferences refer not only to the search itself, but to the style, presentation, and appropriateness of the search results which can not only be a list of links but delivered as synthesized living document products incorporating new media elements.

Some helper BOT embodiments will help people to perform financial transactions requiring highly sensitive and personal information such as credit card numbers, bank account information and the like. These embodiments require the use of BOT security. BOT security will utilize x.509 digital certificate technology assigned to the avatar by its human owner. The cryptographic key will be utilized to perform all related transactions and protect any information deemed sensitive on behalf of its owner in a secure manner through secure network tunnels.

Further embodiments enable an extensible set of commercially available BOTs to be obtained on the MyBOTs.Tv web site in the BOTS Store. This has begun with the 12 “EmBOTiments” presented here. These BOTs perform individual tasks autonomously but may also work in collaboration with each other. Each BOT processes inputs and can be parameterized. Hence, a BOT API enables the creation of stored programs that capture the teamwork interaction and makes their function re-usable. An extensible grammar makes it possible for the evolving baseline of useful stored programs to be called by name so that BOT teams can be dispatched by the user's avatar on demand.

### FIELD OF THE INVENTION

The present invention relates to intelligent systems, particularly for classes of applications that pertain to intelligent automated assistants, autonomous agents, digital libraries, search engines and BOTs.

### BACKGROUND OF THE INVENTION

Today it seems we separate the platforms by which we experience passive entertainment activities from interactive computing applications and activities. The United States ranks the highest among other countries in the amount of time that is spent by individuals watching television. In addition, it is also ranked the lowest among same countries as far as the average score by 12^{th} graders on standardized tests. There is a strong hint that there is some correlation between the two. If Interactive Television however, provided channels with seamlessly integrated applications and computing services, and it became the platform by which our students synthesized reports, conducted research, or could easily satisfy a request to instantly learn about a topic of interest (with definitions and video demonstrations), perhaps there can be a greater academic return on the amount of time we already invest in Television watching. Although there has been some progress with set top boxes and gaming interfaces, Cable TV channel selection interfaces and guides don't offer much in the way of integrated interactive applications and services the way smart phones do. The massive investment of time that we spend in front of the TV can become a more Interactive Television experience that is closer to how we interact with our smart phone apps.

This experience would foster a healthier mix of both passive and interactive channels. It would feature verbal interaction with a personal assistant (in the form of an avatar) that helps users to be more efficient by processing their requests for services and dispatching the required tasks to user's underlying helper BOTs that perform them. At least one of the channels would be Internet access with all the enabling plug-ins for video and chat. There would be gaming and teleconferencing channels as well. There would most certainly be a channel just for robust searches.

However, today's search engines do not permit a dynamic, flexible, and/or personalized process. As the number of applications we use increases with, as many consumer devices, smart phones, tablet computers, and the like, that are able to run software applications to perform various tasks and provide different types of information, the ability for users to master them all and supply information to them becomes unwieldy.

Helper BOTs will provide the deep personalization and rich interactivity that the consumer craves by referencing a user's profile and behavior, resulting in delivery of information products and services much more relevant and valuable to the user than we may experience currently. Both online and mobile users will become increasingly reliant on BOTs in place of or in concert with search engines, to procure relevant information. These helper BOTs will have the ability to automate human-like reasoning and problem-solving, and better analyze and predict our needs for digital content.

Many more providers of digital content will be offering their own BOT virtual assistants and “smart” apps offering services that mirror how you would interact with a sales assistant that already knows you very well and thus would be able to recommend or advise you on products and services. BOT empowered searches have increased depth and breadth by direct access to libraries of digitized multimedia content in addition to the World Wide Web and the obvious database of TV programs or movies native to the Cable TV embodiment. These searches are customized based on preferences provided by the searcher and assisted by a wizard at creation time, also allowing for customization of search results and their integration into living documents such as reports, spreadsheets, and/or business presentations, etc. These searches can be reversed, bringing about alerts that can be extremely timely and helpful to people that use this feature. All alert information and task completion status information from helper BOTs can be delivered by the avatar or directly by email, text, smart phone applications—all integrated by one entertainment operating system and delivered on your flat screen television, gaming interface, laptop, tablet, car dashboard interface, or smart phone.

### SUMMARY

According to various embodiments of the present invention, a personal helper BOT system is implemented on an output device such as a big screen television enabled by a TV based browser to provide the MyBOTs.Tv web site and its BOT products and services to the consumer. In various embodiments, the personal helper BOT system utilizes a customizable personal assistant in the form of an avatar to engage its owner in a conversational manner to coordinate activity of a team of autonomous helper BOTs. Among a variety of other tasks, BOTs collaborate to create the owner's schedule, maintain his/her to-do list, obtain personally interesting information, automate personalized services, perform web site transactions to satisfy goals, leverage web apps as tools, complete tasks and/or synthesize useful products and documents for their users.

According to various embodiments of the present invention, the personal helper BOT system coordinates the individual activities of autonomous web robots (each of which specializes in its own function) such that the net effect is teamwork and the owner's ultimate personal help solution. In short, the goal here is foremost to assist by offloading the task from the user before finding ways to assist the user with the task. In some embodiments, BOTs will learn to do a task autonomously—thereby removing the need to assist with it because it has learned how to do it completely.

Furthermore, the personal helper BOT system of the present invention may, in at least some embodiments, coordinate the team of BOTs in ways that serve the owner in achieving more focused and/or complex goals than would otherwise be provided by any single BOT's services.

The underlying Digital Library Architecture, user directed search filter, and BOT security architectures are each implemented, in at least some embodiments, to enable BOTs to perform more powerful and helpful tasks individually or as a team within those embodiments.

According to various embodiments of the present invention, intelligent helper BOT systems may be configured and/or programmed to provide different types of operations, functionalities, features, applications and/or products, and/or to combine a plurality of features, operations, functionalities, applications, or reusable programs by way of a device on which it is installed. In some embodiments, the personal helper BOT systems of the present invention can perform any or all of: actively eliciting service requests from a user, interpreting user directives, disambiguating among competing directives, requesting and receiving clarifying directives or canceling directives as needed, and carrying out or initiating service requests based on the understanding of the directive. Directives can be executed, for example, by activating and/or interfacing with any applications, other BOTs, web sites, services that may be available on the device, underlying systems available to MyBOTs.Tv, as well as services available over an electronic network such as an intranet or the internet. In various embodiments, such activation of external functionality can be performed via remote procedure calls, utilizing their API's, or by any other suitable mechanism. In this regard, the personal helper BOT systems of various embodiments of the present invention can unify, simplify, classify, organize, and/or rank order tasks for its users and improve the user's experience with respect to many different applications of an electronic device and how it works with the internet but also significantly remove the owner's dependency on the device and its functions by offloading the work to his or her staff of personal helper BOTs.

In some embodiments, it will be the case that one entity will have BOTs that interact with the BOTs of another entity, and perform transactions—completely autonomously and without intervention from the owners of either of the BOTs who completed the transaction.

The user can thereby be relieved of tasks that he or she can effectively off load to the helper BOTs and/or have the burden of managing and negotiating the on-going learning curve of new applications and deeply nested but nevertheless needed functionality. In some embodiments, the stored procedures that automate the teamwork activity will have already mastered and simplified the application functionality that would otherwise have been a challenge for the user. In these embodiments, the intelligence encapsulated by the BOTs will involve deep knowledge and understanding of software use case functionality on the device as well as on the web—thereby removing not only the complexity as the number of apps scales up, but the need for users to be assisted with it. Supportive studies can be conducted regarding user expectations for functionality and all aspects of these use cases can be automated first to create an array of BOT services that in the limit will be endless.

In addition, in various embodiments, the helper BOTs of the present invention provide a believable personal assistant in the form of a customizable avatar that the user may find much more socially inviting and more like a companion and/or a real person that they may talk to and simply ask for help. The user can engage in forms of conversational dialogue with the avatar using any of a number of available input and output mechanisms, such as for example speech, gaming interfaces, graphical user interfaces, text entry, car dashboard interfaces and the like. The BOT system can be implemented using any of a number of different platforms, such as device API's, the web, email, gaming interfaces, TV based browsers, digital media receivers, new entertainment enabling operating systems and the like, or any combination thereof.

Requests for additional information required to complete a service request can be presented to the user as a question from the avatar as part of a conversation. Short term memory is engaged by keeping service requests recently executed in local memory of the current session or in a short term memory cache of a fixed size using for example, a first in first out caching scheme. Long term memory can be engaged so that successfully fulfilled service requests are remembered using case based reasoning, among other artificial intelligence techniques, recalled, replayed, adapted, and resaved with new indices that can include the user's demographics.

In addition, in various embodiments, the conversational interface between the user and the avatar will gr over time to include words and phrases used to call stored procedures created by way of the MyBOTs.Tv API. Those skilled in the art will recognize opportunities to use this API to write programs that coordinate BOT activity in specific ways that satisfy their business, social or otherwise functional requirements.

In various embodiments, the personal helper BOT system will fulfill help service requests that take into account how the request by its nature needs to be fulfilled and respond accordingly, for example, it will certainly recognize opportunities to serve its owner by sending useful perhaps critical information at just the right time, send letters on his or her behalf, provide alerts that have been requested and suggest soft-alerts based on information it knows about its owner, and temporally injecting events into the owner's calendar and/or to do list based on schedules that are either fixed or are temporally calculated.

In various embodiments, the system employs external web sites in order to fulfill a service request. According to technology as it exists today, in order to get full functionality out of many web sites providing applications that are not interrelated, it almost always requires the web site user to re-enter his or her information over and over again. The popular use of helper BOTs will require a paradigm shift in which web sites “BOT enable” themselves. Our helper BOTs will securely carry all of our personal information—thus making it possible to dock itself at a BOT enabled web site, exchange the necessary information required to complete a transaction, disconnect after having persisted the information at the site or perhaps opting not to do so, then move on. This is far more efficient when you think about why fast food restaurant chains implemented the fast food drive through function. Do we give McDonalds corporation our name and demographic information then go to McDonalds and say “Hi, you know me already I'd like a hamburger and fries?” Then after this, do we go to Burger King and Wendy's web sites and log our information with them again too so we can go there and say “Hi, you know me now, can I have a Whopper or a Frosty please?” The current means for obtaining various services from multiple web sites and re-entering information simply is not the most efficient way to set up rapid sales. In a new era when those familiar with recent trends in e-commerce are talking about omnishopping we must prepare in anticipation of billions of fast food like service requests per day. The BOT will potentially have access to the entire array of an individual's personal and financial information. Part of the power in the BOT API will be the programmable and configurable rules, preferences, security and otherwise, that will govern how the BOT enabled web sites access and utilize this information. For example, a person's personal settings for TV Show preferences could certainly also be applied so that person's BOTs could be renting movies or purchasing games if the owner decided to enable that association. BOT enabled web sites will only have access that is provided by the owner. In some embodiments, owners will supply a dollar amount limit up to which a BOT can purchase an item without telling them, and then simply inform them than an action has been taken

In some embodiments as well, the generic functions the helper BOT system uses to provide services to the owner presume device independence. For example, when these embodiments employ additional functionality powered by external services that may be native to the delivery device, the generic functions will have to be instantiated based on the features of the device. That is the helper BOT system will be able to detect the device and dispatch the appropriate version of the generic function for that device, such as dialing a telephone number, sending out a formal letter or email, or calling a web service.

In various embodiments, the system of the present invention can be implemented to provide relief in any of a number of different domains. Examples include:
Take your calls and deliver your messages (according to your preferences)
Find you a job and fill out numerous job applications for you.
Knows how to screen prospects and find you a mate
Find you entertainment
Create you a personal TV guide based on your value preferences.
Create you a personal news paper (your interests, your values)
Pose personal challenges
Personal goals for weight loss and takes your reporting data and makes stats it then presents back to you as a cumulative report later on
Gives you academic quizzes (and uses your stats to make you better at your weakest areas)
Find news you are likely to be interested in hearing and send it to you.
Push word definitions to you (based on something you have read).
Push inspirational stories or scriptures to you based on something you went through.
Tells you Happy Birthday and remembers your birthday and everyone in your friends or family.
Remembers dates that are sentimental to you and pushes you messages so that you know the BOT is thinking about you or people you care about.
Accumulate Totals on statistics of interest.
Keep Statistics and statuses
Alert you when certain conditions arise
Remind you about your car maintenance schedule
Help you keep up with your pet care and maintenance tasks.
Help you keep up with schedules for taking medicine or giving medicine to the cared for.
Remind you about other possessions maintenance schedule (washer dryer TV computer other cars, jewelry etc)
Works with other BOTs to provide you with a to do list Finds bargains for you (and sends them to you by link or otherwise)
Finds Coupons
Suggests ideas related to your interests.
Agents that answer questions (FAQS) about any topic (i.e. hobbies)
Finds knowledge or resources and reports it to you.
Your BOT should be able to fill out and submit job applications with job seeker sites provided that these sites are “BOT-Enabled.”
Manage e-mail 100%.
Maintain social media pages and manage content.

One skilled in the art will recognize that the above list of potential applications or domains is merely exemplary. In addition, the system of the present invention can be implemented in any combination of the following tasks.
Education: Child asks BOT to create a report on volcanoes.
Adult asks BOT to create a newspaper with only “good” news.
BOTs are sent out by a searcher to a network of family members, and then BOT retrieves information from each family member and delivers it back to the searcher.
For example a BOT could be used to create a family photo album or to use an ancestry site to build the family tree.
Future would be globally impacting like the leading social media sites but it will be . . . “point your BOTs to www.conmetomvsite.com” then people will send BOTs . . . but the target site must be ready to host the BOTs as well (1) recognize them (2) provide secure data transfer (3) enable BOT to fill out any applications or perform some financial transactions for the user. These will be referred to as “BOT-enabled web sites.”
BOTs should be able to find you a deal, present it to you, and then you say “Buy it” BOT should be able to do that for you and the next thing is you have the product delivered to you or drop shipped to someone you love.
BOT Security will evolve naturally as did cyber security applications.
Say to Avatar: “Email my sister and tell her she will be ok after the operation” and BOT executes the command.
Say to Avatar: “Write a letter to the bank authorizing permission for my wife to access my account” and BOT executes the command.
Say to Avatar: “Let my ex-wife know that the child support will be arriving after the 18^{th} of the month” and BOT executes the command.
Say to Avatar: Global commands to your whole family: “Send a Happy birthday card to everyone in my family birthday” but first alert me so I can choose the card I want to send to them (this will require the card company web site to be “BOT-Enabled”).
Set your BOT up to surprise you with a gift for your birthday.
Financial BOT Services will require the emergence of “BOT Security” services, applications and products.
BOTs will teach people who want to learn.

### BRIEF DESCRIPTION OF THE DRAWINGS

FIG. 100 shows an integrated Helper BOT solution organized into architectural layers.

FIG. 200 is a context diagram identifying external factors and how they are related to the underlying Digital Library Architecture used to power Research BOTs and user-directed searches.

FIG. 300 is a context diagram identifying external factors and how they are related to the YOURSearch filter and search engine.

FIG. 400 is a context diagram identifying external factors and how they are related to MyBOTs.Tv Helper BOT Applications, Products, and Services.

FIG. 500 is the MyBOTs.Tv class diagram showing a representative group of the system's base classes, their attributes, operations (or methods), and the logical relationships among objects.

FIG. 600 is a sequence diagram modeling the programming logic in MyBOTs.TV for the function under the Digital Library Architecture that presents search results as rank order listings in an order most likely to satisfy the user. Helper BOTs utilize this function to deliver BOT services, products and/or applications.

FIG. 700 is a sequence diagram modeling the programming logic in MyBOTs.TV for the function under the Digital Library Architecture that creates physical Digital Library Objects.

FIG. 800 is a sequence diagram modeling the programming logic in MyBOTs.TV for the function under the Digital Library Architecture that creates, activates, and/or deactivates physical Digital Library users.

FIG. 900 is a sequence diagram modeling the programming logic in MyBOTs.TV for the function under the Digital Library Architecture that allows the Librarian actor to induct new elements and metadata into the Digital Library.

FIG. 1000 is a sequence diagram modeling the programming logic in MyBOTs.TV for the function that processes search results, decomposes them and their links or attachments and captures contents with a markup language,

FIG. 1100 is a sequence diagram modeling the programming logic in MyBOTs.TV for the function under the Digital Library Architecture that loads data into Channels (popular filters set up for large sectors of the consumer population)

FIG. 1200 is a sequence diagram modeling the programming logic in MyBOTs.TV for the function that synthesizes document products out of search results and delivers them to the searcher as formatted synthesized documents of various document types.

FIG. 1300 is a sequence diagram modeling the programming logic in MyBOTs.TV for the function under the Display Engine that knows how to display and allow user interaction with all document types.

FIG. 1400 is a sequence diagram modeling the programming logic in MyBOTs.TV for the functions specifically under YOURSearch that decompose search engine results and put them into markup language so that they may be used to construct documents and/or more personalized search products and applications for users.

FIG. 1500 is a sequence diagram modeling the programming logic in MyBOTs.TV for the function that processes inbound service requests and puts them into a queue for processing.

FIG. 1600 is a sequence diagram modeling the programming logic in MyBOTs.TV for the function that processes service requests, prepares and puts responses into a queue for processing and delivery to the user.

FIG. 1700 is a package diagram showing the dependencies between major elements of a the Helper BOT System.

FIG. 1800 is a data flow diagram (DFD) showing the “flow” of data through the YOURSearch component of MyBOTS.Tv—modeling its process aspects.

FIG. 1900 is a diagram showing how users require search results that are far more customized to their needs and preferences.

FIG. 2000 is a data flow diagram (DFD) showing the “flow” of data through the YOURSearch component (1800) of MyBOTS.Tv and modeling the delivery of alerts to end users.

FIG. 2100 is a data flow diagram (DFD) showing the “flow” of data through the BOTs component of MyBOTS.Tv, modeling the process of providing BOT Services, Applications, and Products to end users.

FIG. 2200 is a deployment diagram showing the physical deployment of MyBOTs.Tv and the hardware components running on each node and how different pieces are interconnected.

FIG. 2300 deployment diagram models the physical deployment of MyBOTs.Tv and shows how the servers are connected to the inputs and outputs.

FIG. 2400 is a data flow diagram showing the internal components of the underlying Digital Library Architecture.

FIG. 2500 is a use case diagram portraying the users of MyBOTs.Tv and the various ways they interact with the YOURSearch component of the system.

FIG. 2600 is a use case diagram portraying the users of MyBOTs.Tv and the various ways they interact with the BOTs component of the system.

FIG. 2700 is a use case diagram portraying the users of MyBOTs.Tv and the various ways they interact with the process for queueing inbound service requests and assigning BOTs to them.

FIG. 2800 is a use case diagram portraying the users of MyBOTs.Tv and the various ways they process inbound requests and provide outbound responses to users.

FIG. 2900 is a deployment diagram showing the physical deployment of MyBOTs.Tv and how the hardware artifacts are connected and the server farm is segmented by service request type.

FIG. 3000 is a block diagram showing the interaction and connectivity of the hardware components of MyBOTs.TV internal to the servers that process the inbound service request queue.

FIG. 3100 is a block diagram showing the internal components of the CPU processors required for servers of the MyBOTs.Tv Personal Helper BOT System.

FIG. 3200 is a block diagram showing a MyBOTs.Tv Computing Device.

FIG. 3300 is a pictorial depiction of a BOT avatar.

FIG. 3400 is a block diagram showing the components of an embodiment of a MyBOTs.Tv Personal Helper BOT System.

FIG. 3500 is a block diagram showing the components of the BOT security operations.

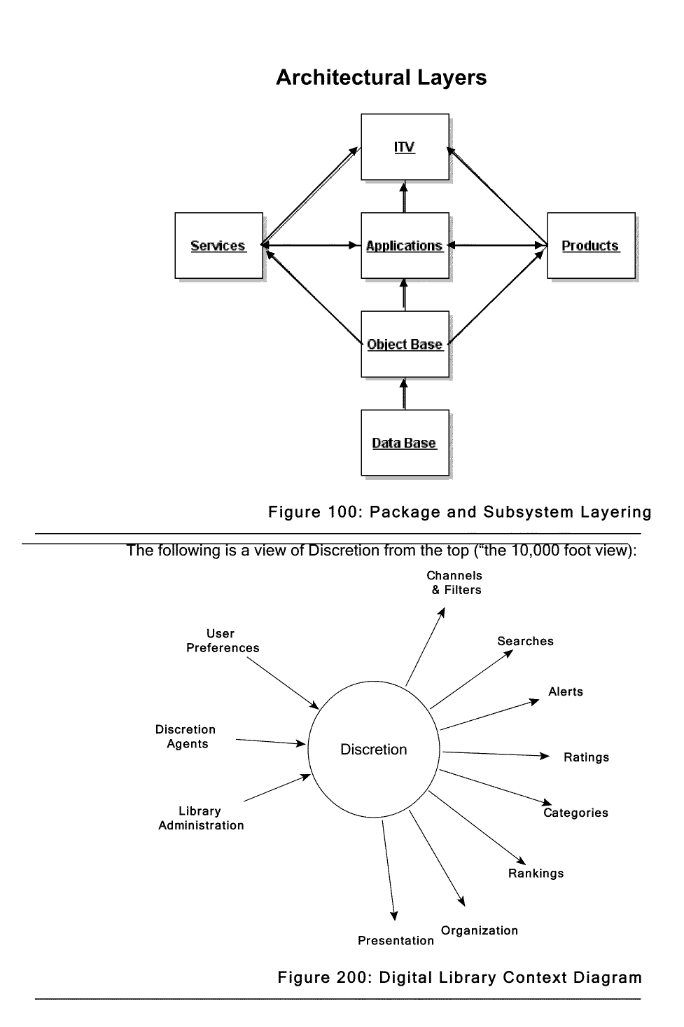

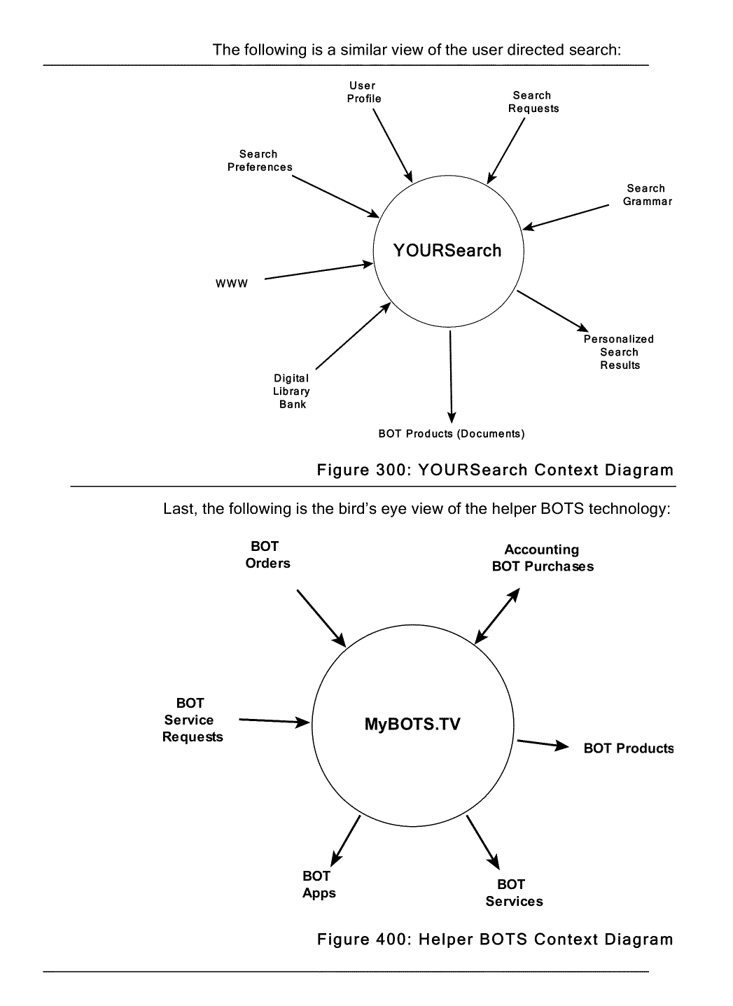

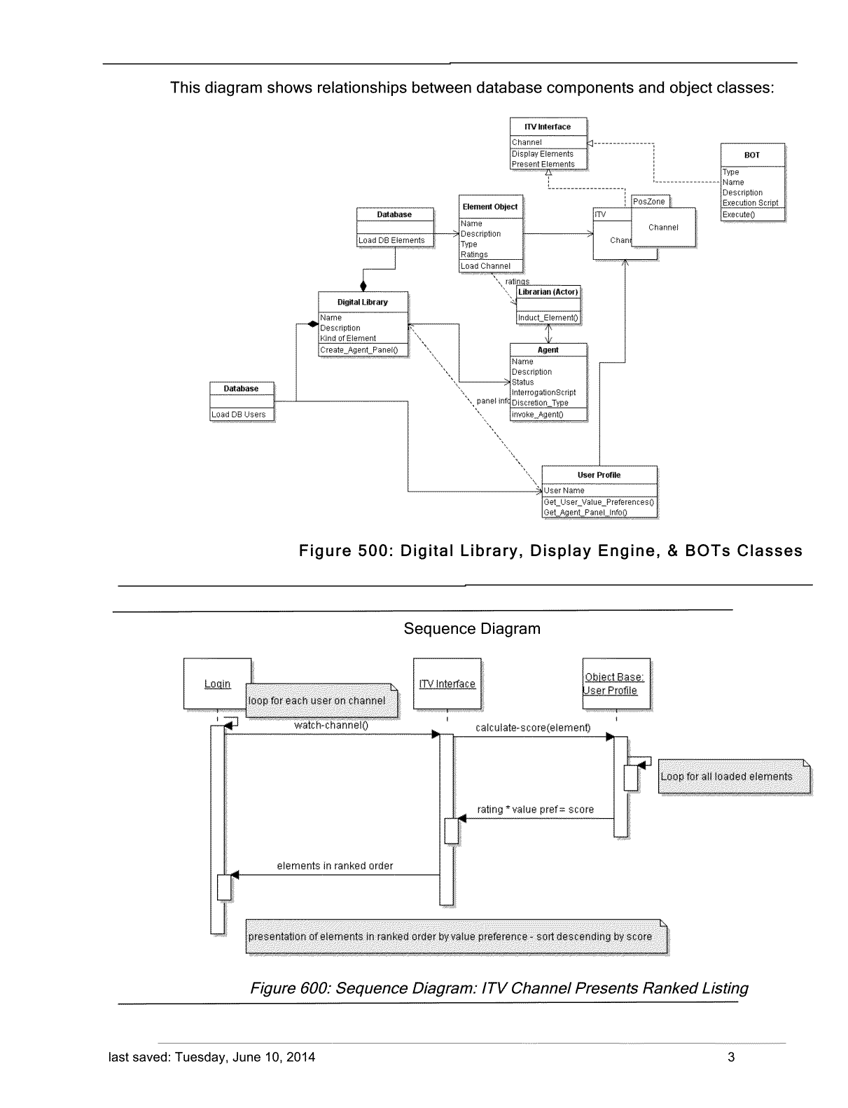

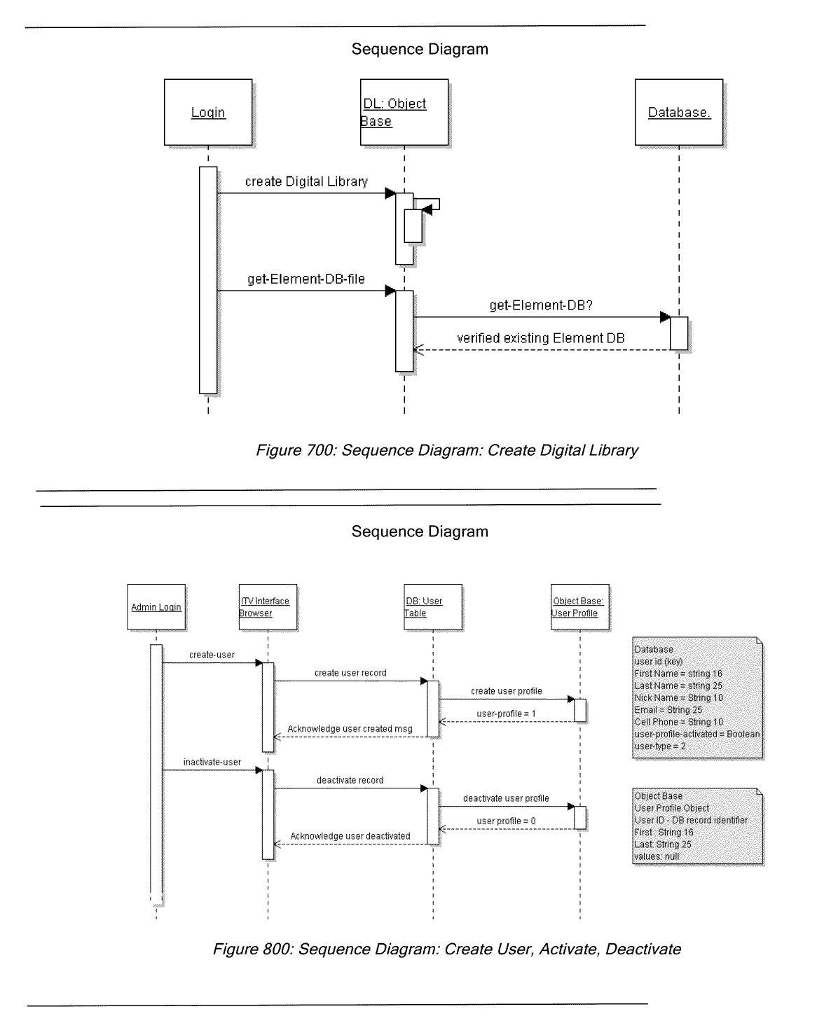

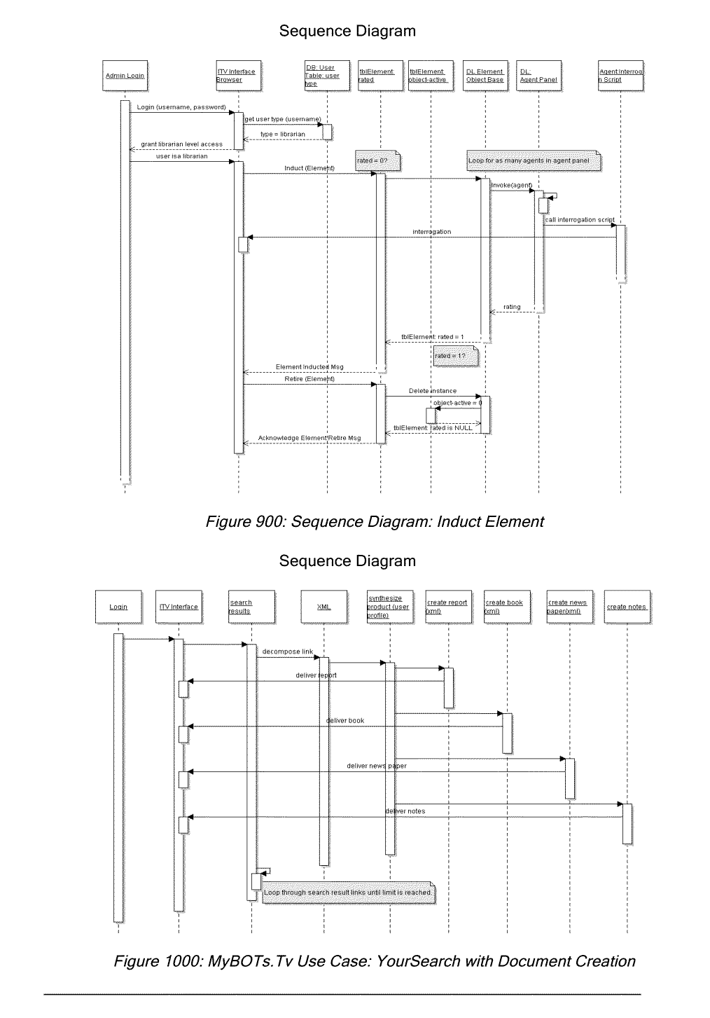

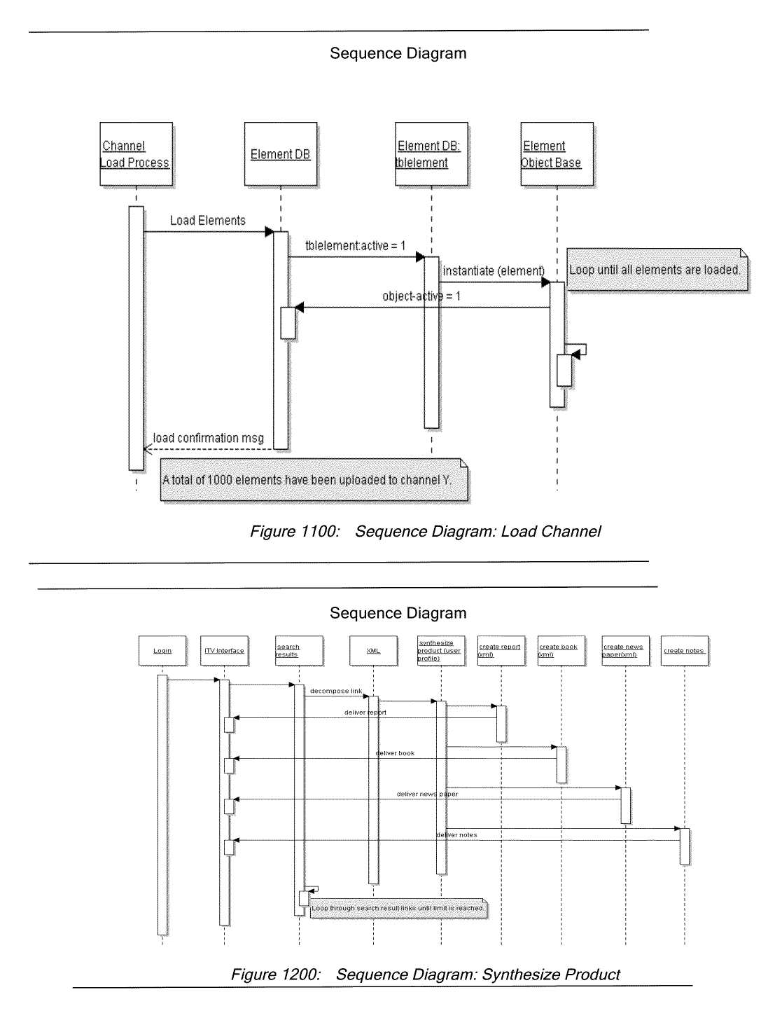

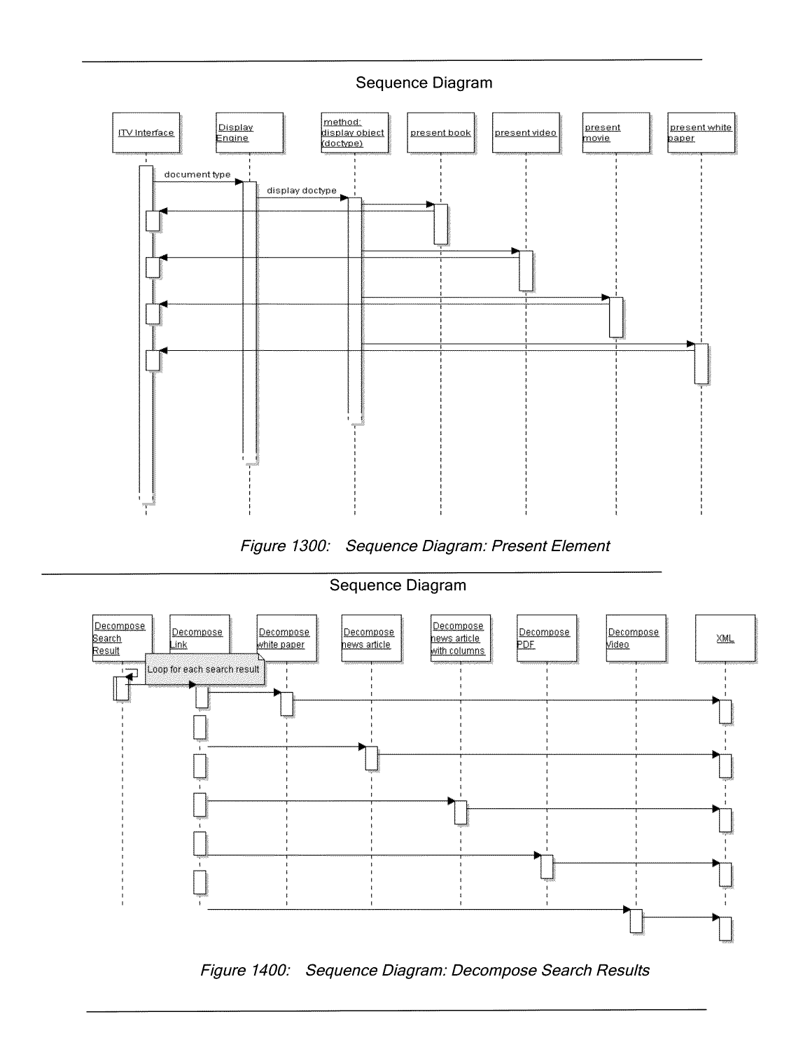

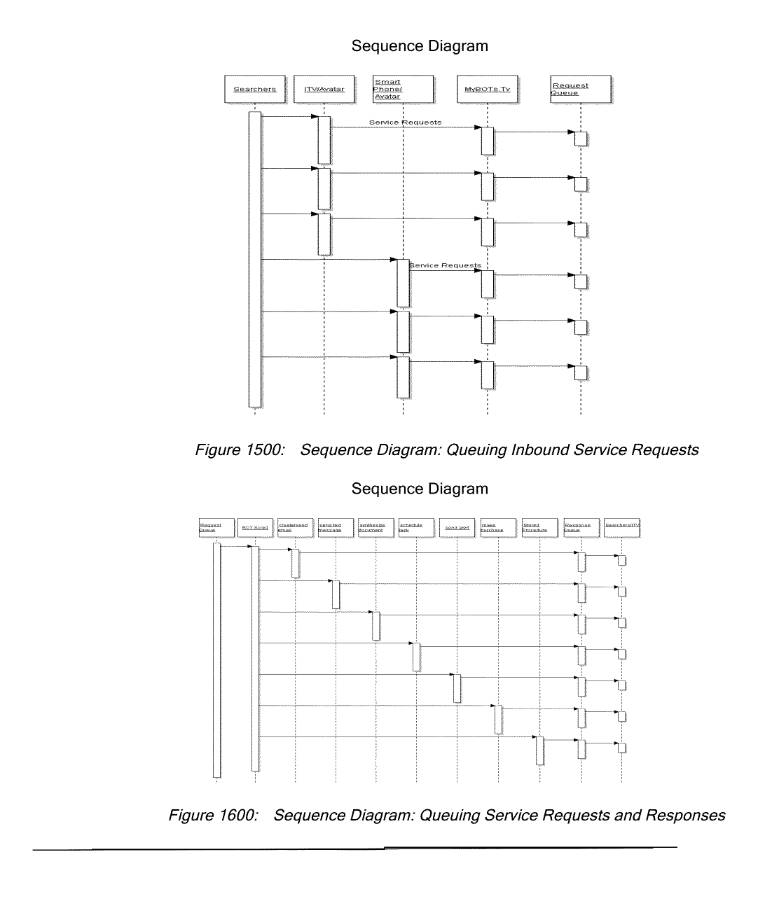

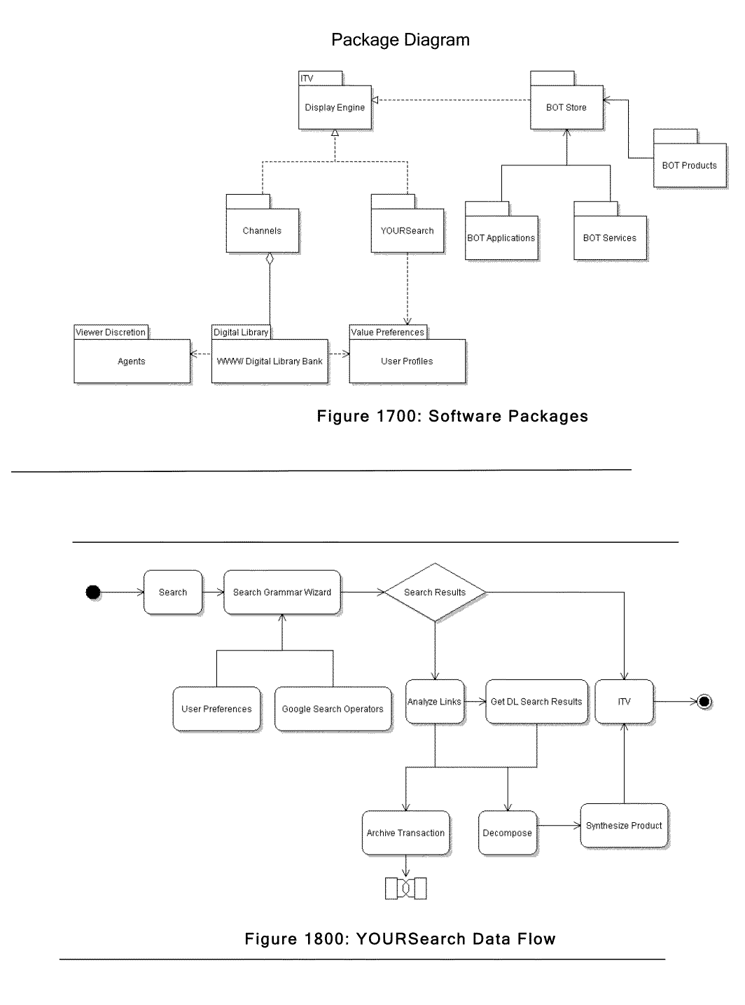

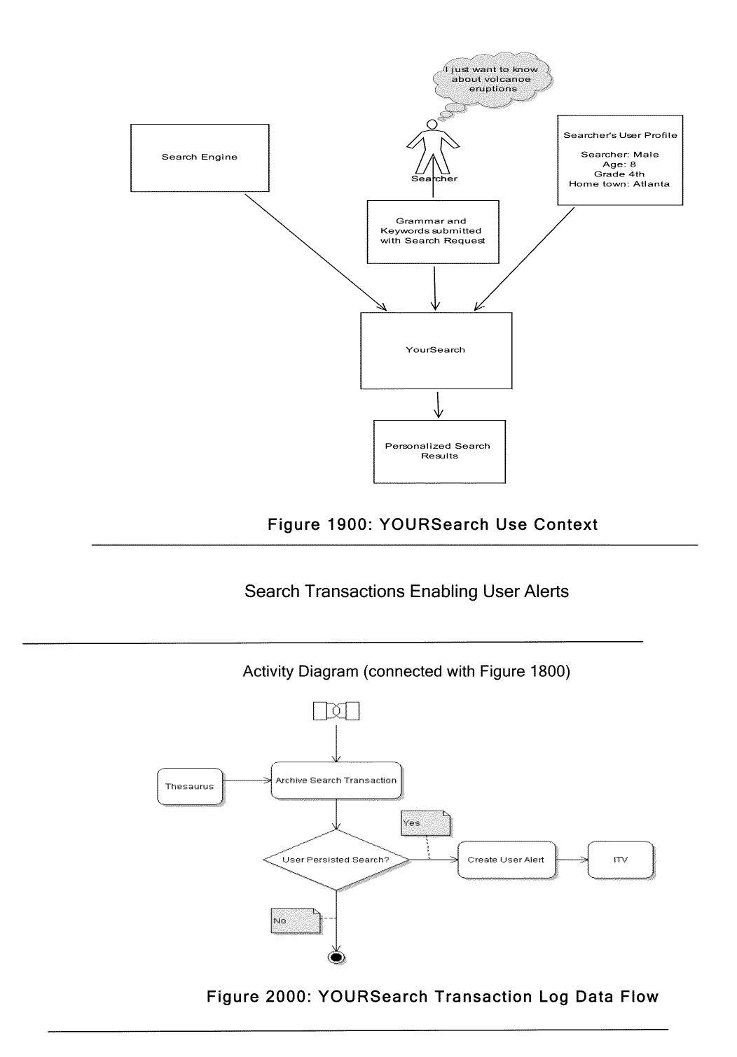

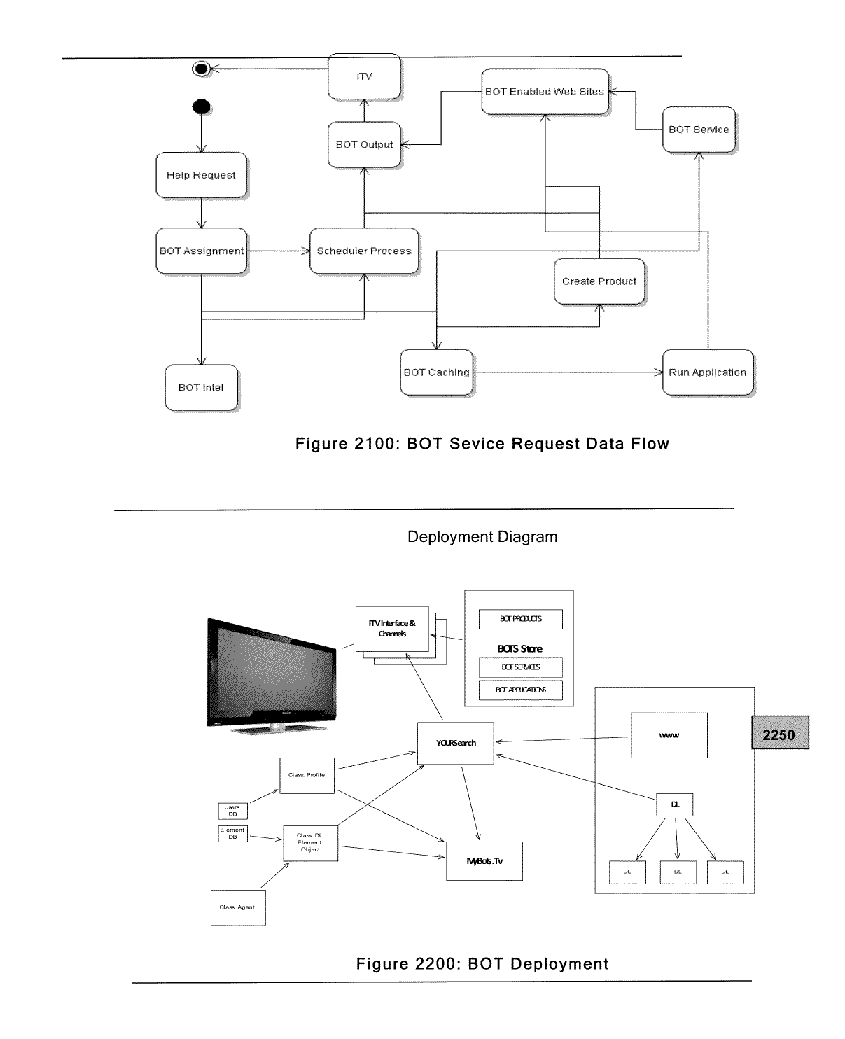

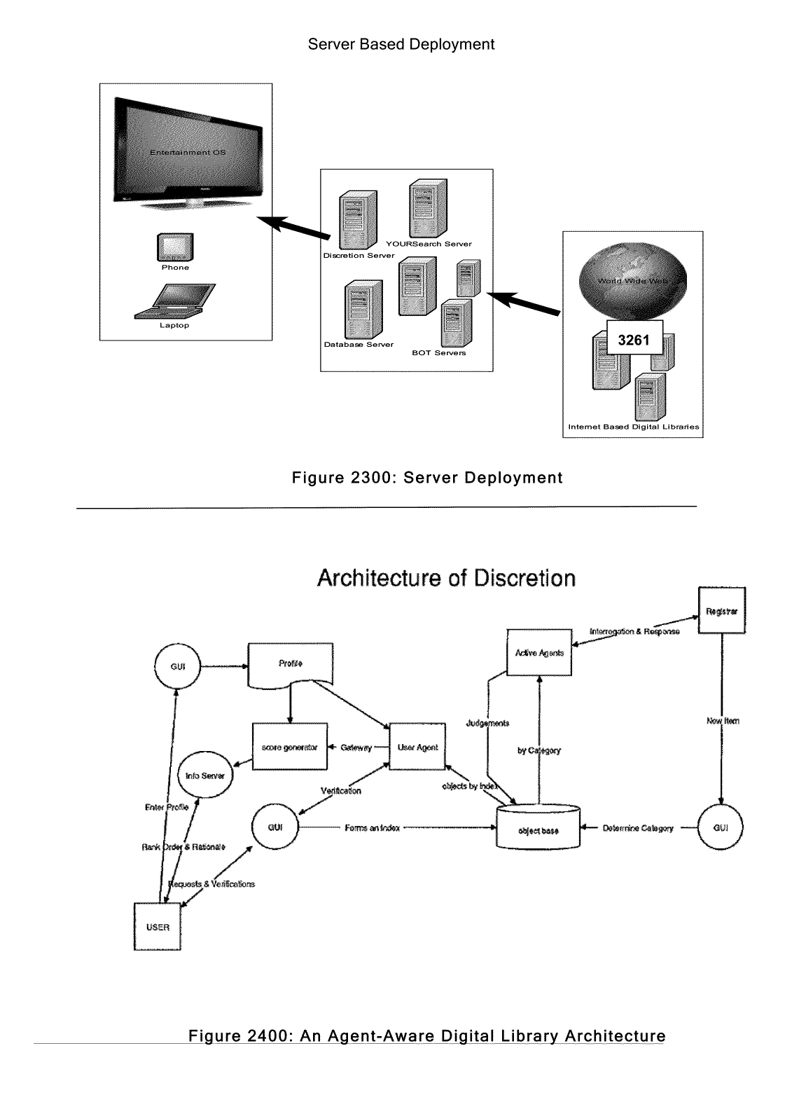

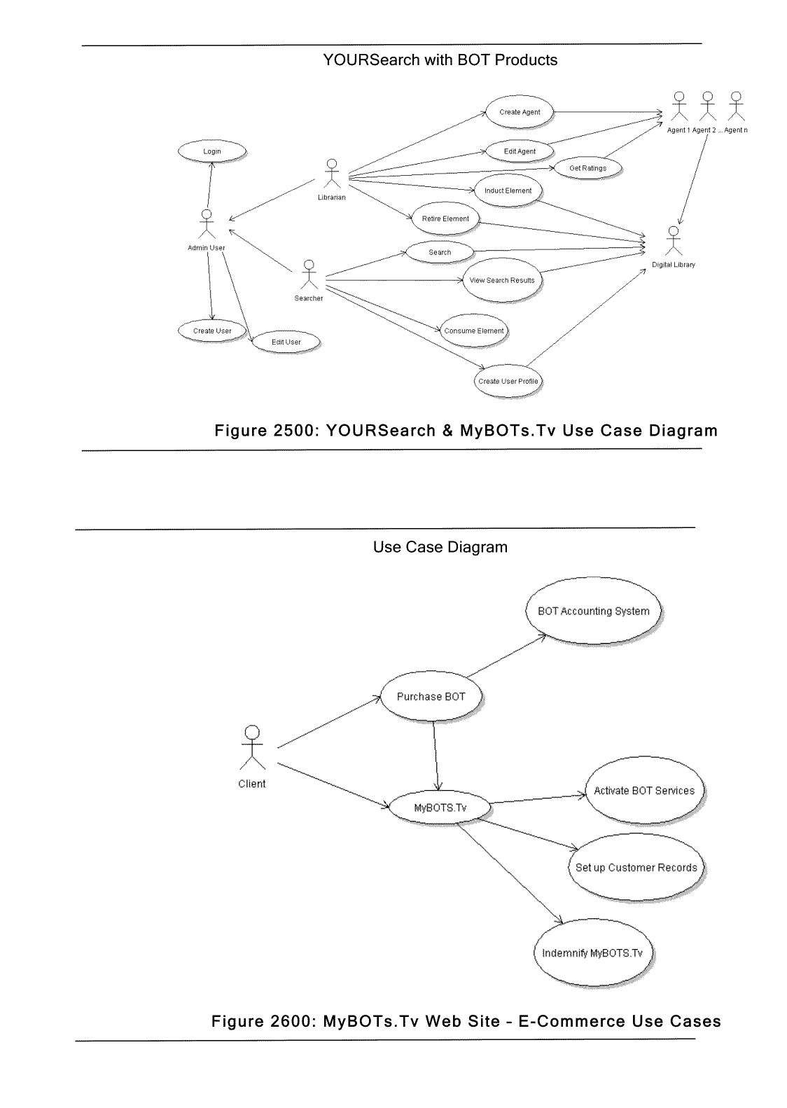

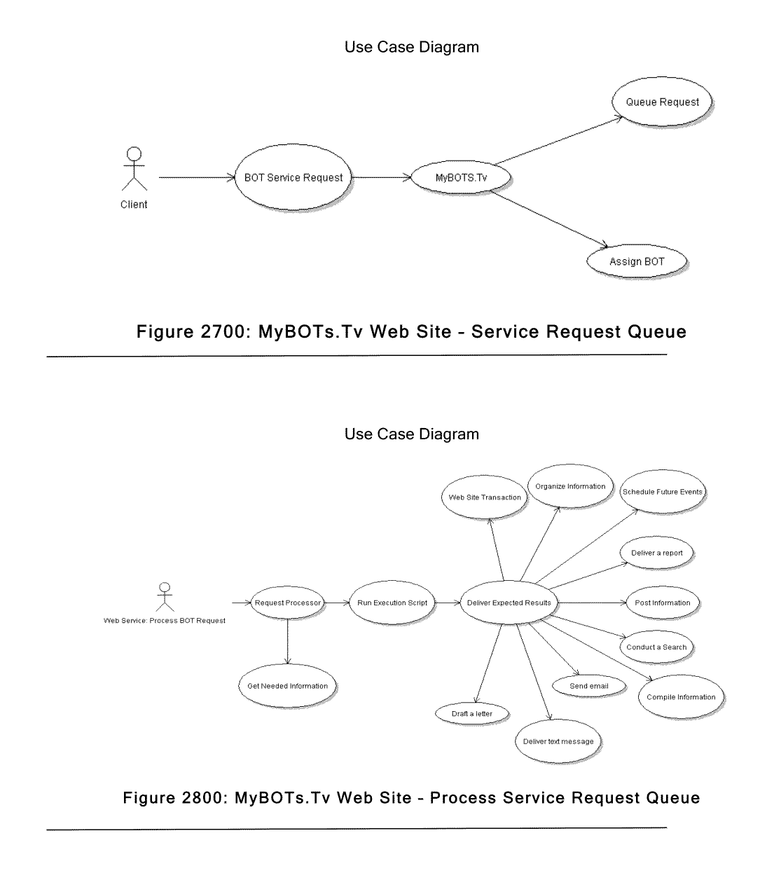

### DETAILED DESCRIPTION OF THE EMBODIMENTS

Various techniques will now be described in detail while referencing a few example embodiments as illustrated in the accompanying drawings. In the following descriptions, numerous specific details are set forth in order to provide a thorough understanding of one or more aspects and/or features described or referenced herein. It will be apparent, however, to one skilled in the art, that one or more aspects and/or features described or referenced herein may be practiced without some or all of these specific details. In other instances, well known process steps and/or structures have not been described in detail in order to not obscure some of the aspects and/or features described or referenced herein.

One or more different inventions may be described in the present application. Further, for one or more of the invention(s) described herein, numerous embodiments may be described in this patent application, and are presented for illustrative purposes. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, architectural, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration. It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for the sake of the disclosure only, and are not to be taken as limiting the disclosure in any way.

A description of an embodiment with several components in communication with each other does not imply that all such components are required. To the contrary, a variety of optional components are described to illustrate the wide variety of possible embodiments of one or more of the invention(s).

This patent application includes the four main components of the “MyBOTs.Tv helper BOT system,” as follows:
1. Discretion—An Agent-Aware Digital Library Architecture provides a base of elements upon which to build the Helper BOT solution. Unlike a database, Discretion allows for the concept of a digital library of elements which among other things, stores both static and dynamic metadata about the elements. With metadata accessible, the elements may then be much more discretely served to users in accordance with their preferences.
2. YOURsearch (Your Own User-directed Retrieval)—A suite of next generation search tools and filters that change the internet search paradigm as we know it—bringing us into the next generation where searches are more user-directed, user-architected, personalized services that provide accurate results that directly fulfill our requests.
3. MyBOTs.Tv—An exciting development of helper “BOTs” (software bound robots or autonomous agents) that by understanding who we are, are then able to provide a plethora of new and personalized services, applications and products. YOURsearch works by itself as a search engine alternative but may also leverage BOTs to provide more refined, personalized and customized search results.

Interactive TV Interface—An integrated delivery platform that by design, suggests that we upgrade our TV watching experience to include new possibilities. Integration of the kinds of elements we view and interact with, the kinds of experiences we expect, the kinds of educational research we can conduct, the kinds of searches, services and applications we can architect, and with this wealth of integrated information, the kinds of products we can create and market. For once, we seek to unify the delivery platform for consumable entertainment and education providing entities and hope that our culture gets the hint. BOTs that are in communication with each other need not be in continuous communication with each other, unless expressly specified by way of procedures created with the BOT API and/or the context in which they are used. In addition, BOTs that communicate with each other may communicate directly by messaging or indirectly asynchronously through an intermediary structure such as a blackboard, a cache, a database or a message bus.

Indirect communication and the passing of intermediate results is necessary in embodiments that utilize context switching. This occurs where one BOT begins the execution of a stored procedure, obtains a result and then requires another BOT to perform a task that it depends and waits on, obtains a result, then goes back to its original execution flow.

Each BOT is an object that has at least the following base attributes: name, description, and execution script. The execution script has lines of code that are executed by processors. The lines of code can be operating system commands, programming instructions, messages, remote procedure calls, and/or web service calls, and various embodiments of gets, puts, and fetches—depending upon various embodiments of BOT services, applications, and/or products.

Further, although process steps, method steps, algorithms or the like may be described in a sequential order, such processes, methods, stored procedures and algorithms may be configured or programmed to work in alternate orders. Hence, any sequence or order of steps that may be described in this patent application does not, in and of itself, indicate a hard requirement that the steps be executed in that order. The steps executed by BOT Teams while executing a team task or the steps performed by a single BOT while processing a customer service request may be performed in any order practical. Some steps may be performed simultaneously and/or in parallel despite being described as occurring sequentially or non-simultaneously. Moreover, the illustration of a process by its depiction in the drawings does not imply that the illustrated process is exclusive of other variations, modifications and/or updates. Any changes to the drawings to not imply that the illustration of the process as depicted before the changes are in any way invalidated by the changes.

Although described within the context of Internet BOT technology, it may be understood that the various aspects and techniques described herein may also be deployed and/or applied in other fields of technology such as robotics, intelligent automated assistants, various applications of autonomous agents, or any other involving human and/or computerized interaction with software or complete automation of the function requiring such interaction. Other aspects relating to collaborating teams of software robot technology are disclosed in one or more of the following reference
IEEE International Conference on Systems, Man, and Cybernetics, 1997 Citations: (2) An Agent-Aware Digital Library Architecture for Interactive Television
IEEE Computer Society Press, 1993
Paper: A Virtual Knowledge Architecture for Intelligent Robot Planning

Hardware Architecture

The helper BOT system disclosed herein may be implemented on hardware or a combination of software and either physical or virtual hardware. For example, they may be implemented in an operating system kernel, a web service, set top box, parallel processing machine, client server system, and/or server farms supporting highly trafficked web sites with load balancing, web acceleration and/or SSL termination. In specific embodiments, the architectures disclosed herein may be implemented in software such as an operating system, entertainment operating system or in an application running on the operating systems.

According to specific embodiments, at least some of the features and/or functionalities of the various architectures disclosed herein may be implemented one or more general-purpose network host machines such as end-user desktop computer system, network or web server, mobile computing device, gaming system, personal digital assistant, mobile phone, smart phone, laptop, tablet computer, or the like), entertainment operating system, consumer electronic device, music player, or any other suitable electronic device, router, switch, or the like, or any combination thereof. In at least some embodiments, part or all of the features and/or functions of the helper BOT system disclosed herein may be implemented in virtual computing environments. Any such embodiment that implements the functions and features disclosed herein by virtue of virtualized computer systems is also covered by this patent application.

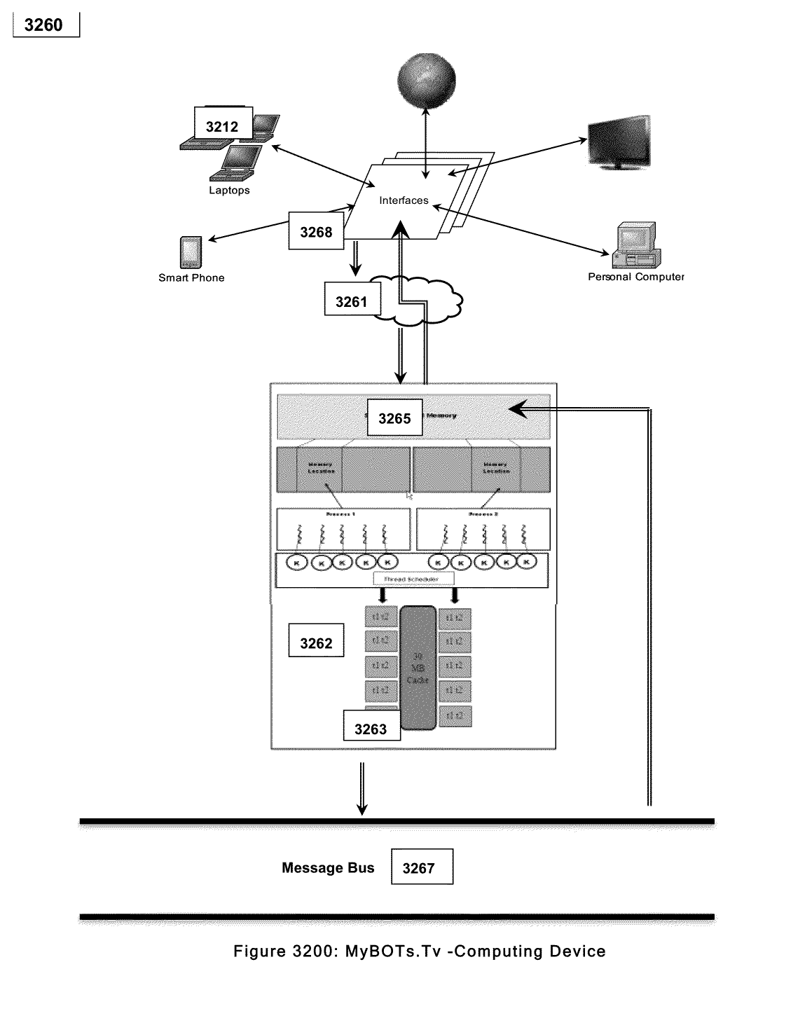

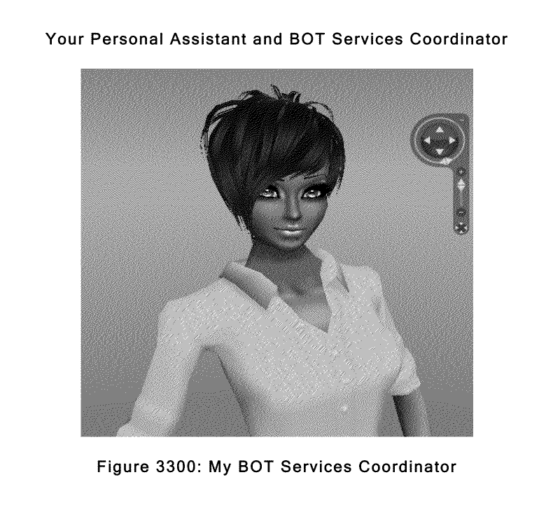

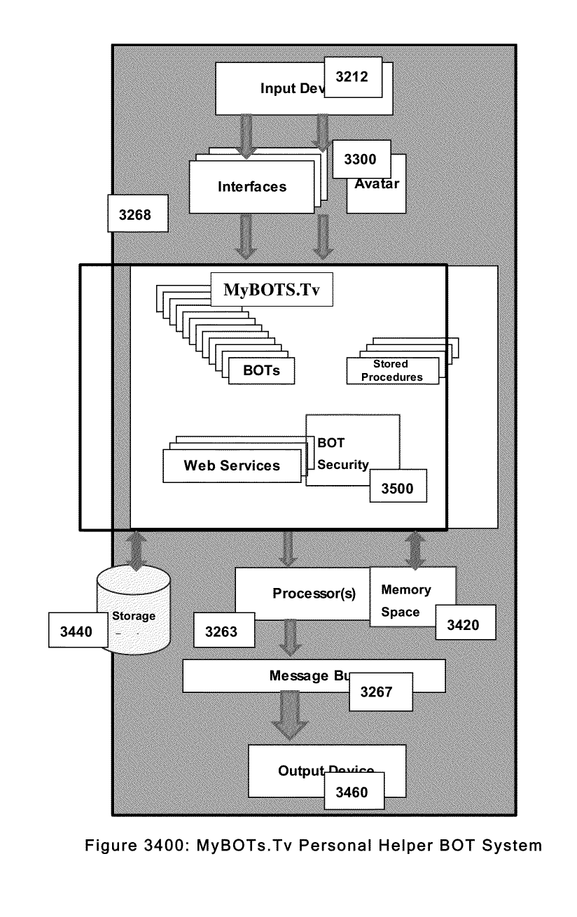

FIG. 3200 is deployment diagram models the physical deployment of MyBOTs.Tv as a computing device that processes input from a variety of sources and interfaces, flows through the Internet and firewall, and is processed by enabling hardware to produce a response for the user.

Refer to FIG. 3200, there is shown a block diagram depicting a computing device 3260 suitable for implementing at least a portion of the helper BOT system features and/or functionality disclosed herein. Computing device 3260 may be, for example an end-user personal computer system, network server or server system, mobile computing device such as a personal digital assistant, mobile phone, smart phone, laptop, tablet computer, or the like), consumer electronic device, music player, gaming system, or any other suitable electronic device, or any combination or portion thereof. Computing device 3260 may be adapted to communicate with other computing devices, such as clients and/or servers, over a communications network such as the Internet or an Intranet, using known protocols for such communication, whether wireless or wired.

In one embodiment, computing device 3260 includes central processing unit (CPU) 3262 and message bus 3267 (such as an Enterprise Service Bus). When acting under the control of appropriate software or hardware, CPU 3262 may be responsible for implementing specific software functions and/or code written to take advantage of the specifically configured and/or programmed hardware capabilities of a computing device or machine. For example, in at least one embodiment, a user's smart phone may be configured, designed, or programmed to function as a helper BOT system using CPU 3262. In another embodiment, the helper BOT system software implemented in the server platform will specifically be architected, programmed and/or configured to take full advantage of the multi-threading capabilities of CPU 3262, while still adhering to a Service Oriented Architecture Model.

In this embodiment, the architecture is a model that combines the processing power of parallel computation with the ease of web service usage.

A web service is a service that can be published, located and/or invoked across the web. As service requests come in to MyBOTs.Tv, and the avatar 3300 has activated and parameterized the right BOTs to respond to it, software processes create one or more threads to execute a portion of the BOT execution script associated with the process. In order to provide parallel execution, a new thread is first created and started for each web service handling a line of the execution script. In some embodiments, the lines of the BOT execution script can be direct calls to web services. Each thread in turn then executes the indicated function of the web service with its input parameters.

In another embodiment of the same architecture, processes may be deployed at the level of the execution lines within the BOT execution scripts. This architectural strategy would potentially optimize performance by giving the operating system threads the ability to find available virtual processors after successfully executing each line—thereby avoiding latency associated with threads waiting to execute because they are dependent on the output of another thread within the process.

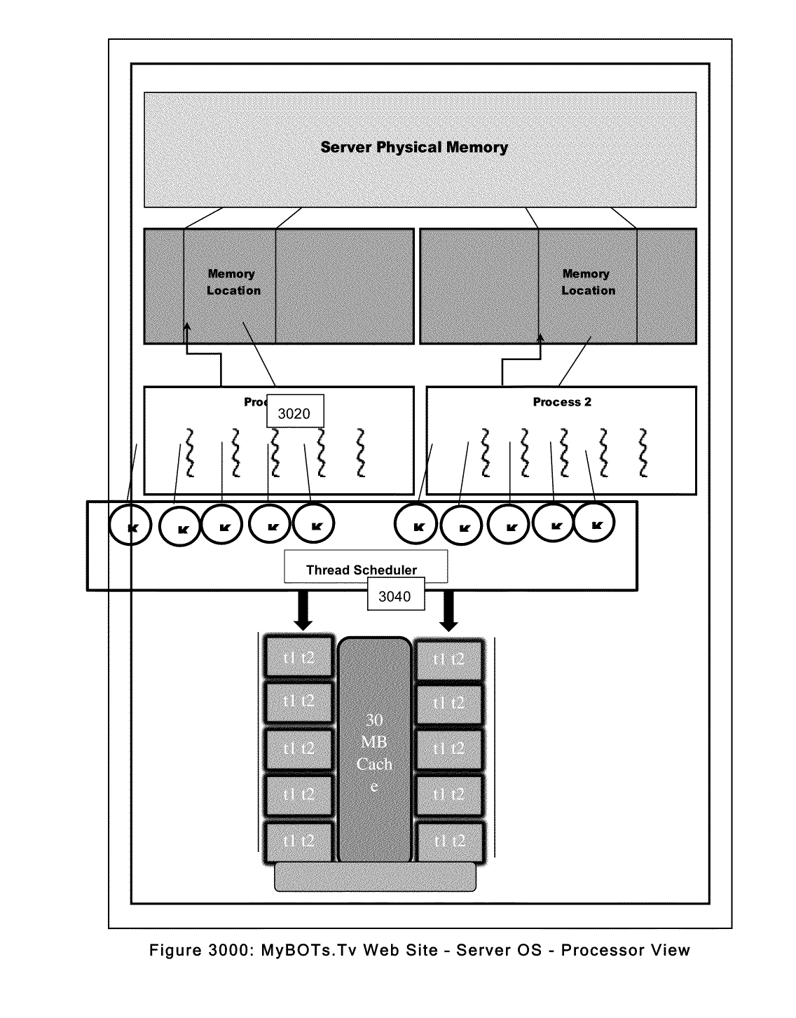

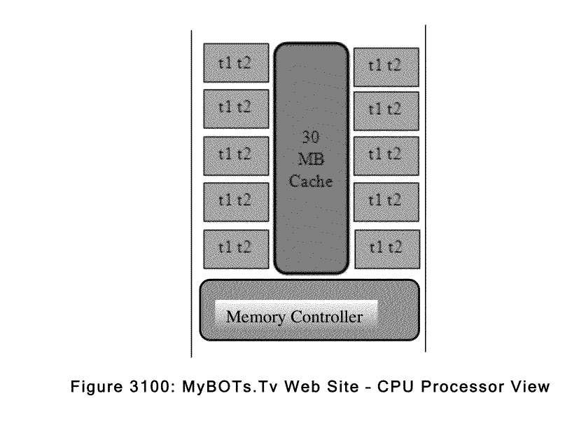

Referring to FIG. 3000, there is a diagram showing what for at least one embodiment of the helper BOT system, the internal processing flow within one server in a distributed computer network will look like.

3020 depicts a software process that is dedicated to processing of at least one server request. In one embodiment, each of the individual lines of instruction in each BOT execution script is presented to a user thread in the Server's Operating System. For the sake of the practice disclosed herein, a one to one mapping of user threads to OS threads is shown. However, the architecture is by no means limited to the one-to-one mapping and will consider one to many, many to many, or any suitable mappings as other embodiments of the hardware architecture. Based on the one to one mapping in this embodiment, each user thread hands the task over to one Operating System Kernel thread (depicted by the circles with K).

Fulfilling a Multi-Threading model, each OS thread processes at least one line of the BOT execution script and is submitted to the thread scheduler 3040 when ready for further processing by a CPU core. Thread scheduler 3040 takes this processor request and fulfills it by passing the task to the processor that is ready and available.

CPU 3262 (also depicted in 3100) may include one or more processor(s) 3263 such as, for example, a processor from the Motorola or Intel family of microprocessors or the MIPS family of microprocessors which feature Hyper Threading Technology (HTT). These core processors have the ability to execute 2 threads simultaneously while each shares core processor resources. When such a CPU is used that has multiple cores, the Operating system thread scheduler will see this as 20 virtual processors if there are 10 cores in the CPU. Hence, the OS kernel thread scheduler will pass execution line to the virtual processor that is available to process next.

In some embodiments, processor(s) 3263 may include specially designed hardware (e.g., application-specific integrated circuits (ASICs), electrically erasable programmable read-only memories (EEPROMs), field-programmable gate arrays (FPGAs), and the like) for controlling the operations of computing device 3260. In a specific embodiment, a memory 3261 (such as non-volatile random access memory (RAM) and/or read-only memory (ROM)) also forms part of CPU 3262. However, there are many different ways in which memory may be coupled to the system. Memory block 3265 or any additional add-on memory space 3420 may be used for a variety of purposes such as, for example, caching and/or storing data, maintaining global variables, storing client settings, intermediate results, programming instructions, and the like.

As used herein, the term “processor” is not limited merely to those integrated circuits referred to in the art as a processor, but broadly refers to a microcontroller, a microcomputer, a programmable logic controller, an application-specific integrated circuit, and any other programmable circuit.

Interfaces 3268 are the devices handling all input to the helper BOT system. Generally, they control the sending and receiving of data packets over a computing network and sometimes support other peripherals used with computing device 3260. Among the interfaces that may be provided are cable interfaces, frame relay interfaces, Ethernet interfaces, token ring interfaces, DSL interfaces, and the like. In addition, various types of interfaces may be provided such as, for example, Bluetooth™, Serial, Firewire, universal serial bus (USB), Ethernet, PCI, parallel, radio frequency (RF), near-field communications/magnetics, TCP/IP, WiFi, frame relay, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 3268 may include ports appropriate for communication with the appropriate media. In some cases, they may also include an independent processor and, in some instances, volatile and/or nonvolatile memory (e.g., RAM).

Although the system shown in FIG. 3200 illustrates one specific architecture for a computing device 3260 for implementing the techniques of the invention described herein, it is by no means the only device architecture on which at least a portion of the features and techniques described herein may be implemented. For example, architectures having one or any number of processors 3263 can be used, and such processors 3263 can be present in a single device or distributed among any number of devices. In one embodiment, a single processor 3263 handles communications as well as routing computations. In various embodiments, different types of helper BOT features and/or functionalities may be implemented in a Helper BOT system which includes a client device such as a personal digital assistant (PDA) or smart phone running client software, and server system(s).

Regardless of network device configuration, the system of the present invention may employ one or more memories or memory modules (such as, for example, memory block 3420) configured to store data, program instructions for the general-purpose network operations and/or other information relating to the functionality of the helper BOT system and/or techniques described herein. The program instructions may control the operation of an operating system and/or one or more applications, for example. The memory or memories may also be configured to store data structures, keyword taxonomy information, user profile information, search element metadata, advertisement information, user click and impression information, and/or other specific non-program information described herein.

Since such information and program instructions may be employed to implement the systems/methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as floptical disks, and hardware devices that are specially configured to store and perform program instructions, such as read-only memory devices (ROM), flash memory, memristor memory, random access memory (RAM), and the like. Examples of program instructions include both machine code, such as produced by a compiler, and files containing higher level code that may be executed by the computer using an interpreter.

In one embodiment, the system of the present invention is implemented on a standalone computing system. Referring now to FIG. 3200, there is shown a block diagram depicting an architecture for implementing at least a portion of a helper BOT system standalone computing system, according to at least one embodiment. Computing device 3260 includes processor(s) 3263 which run software for implementing the helper BOT system 3400. Input devices 3212 can be of any type suitable for receiving user input to the interfaces in 3268, including for example a keyboard, touch screen, microphone (for voice input), mouse, touchpad, trackball, five-way switch, joystick, gaming system controller, and/or any combination thereof. Output device 3460 can be a screen, speaker, printer, and/or any combination thereof. Memory 3420 can be random-access memory having a structure and architecture as are known in the art, for use by processors 3263 in the course of running software. Storage device 3460 can be any magnetic, optical, and/or electrical storage device for storage of data in digital form; examples include flash memory, magnetic hard drive, CD-ROM and/or the like.

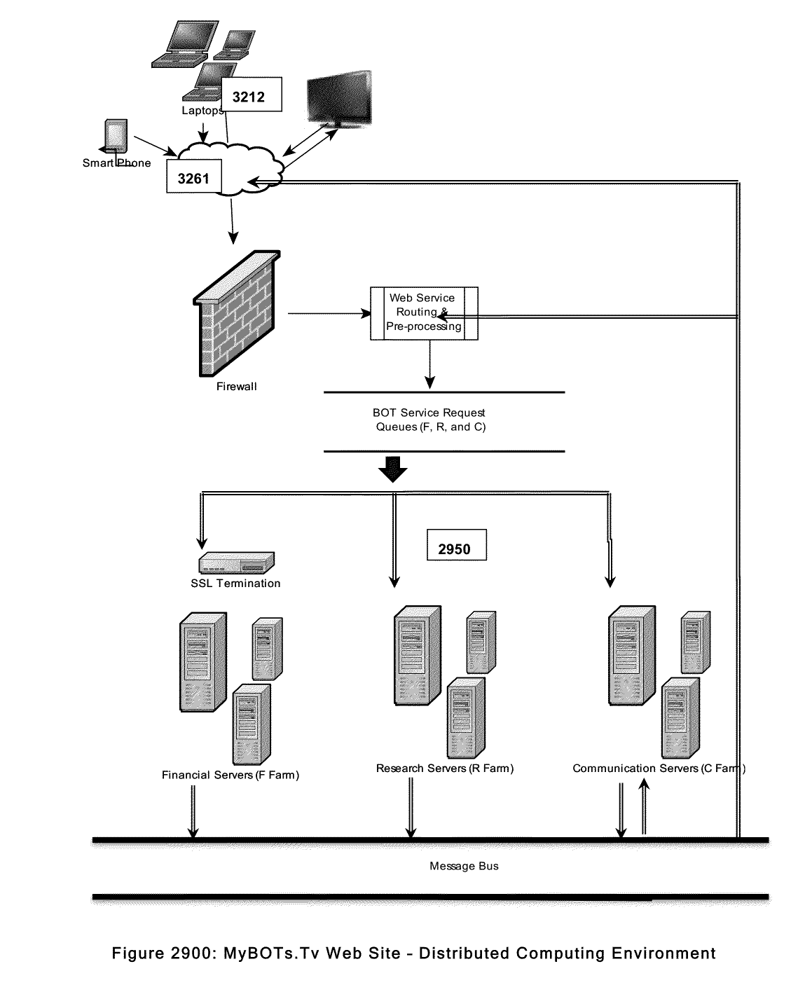

In another embodiment, the system of the present invention is implemented on a distributed computing network, such as one having any number of clients and/or servers. Referring now to FIG. 2900, there is shown a block diagram depicting a service oriented architecture for implementing at least a portion of a helper BOT system on a distributed network, according to at least one embodiment.

In the arrangement shown in FIG. 2900, any number of clients providing input via 3212 is anticipated. Each client may run software for implementing client-side portions of the present invention. In addition, any number of servers 2950 can be provided for handling requests received from clients providing these inputs. Clients providing inputs 3212 and servers 2950 can communicate with one another via electronic network 3261, such as the Internet. Network 3261 may be implemented using any known network protocols, including for example wired and/or wireless protocols.

In addition, in one embodiment, servers 2950 can call external services 2250 when needed to obtain additional information or refer to stored data concerning previous interactions with particular users. Communications with external services 2250 can take place, for example, via network 3261. In various embodiments, external services 2250 include web-enabled services and/or functionality related to or installed on the hardware device itself. For example, in an embodiment where helper BOT system 3260 is implemented on a smart phone or other electronic device, the helper BOT system can obtain information stored in a calendar application, contacts, and/or other sources.

In various embodiments, the helper BOT system 3260 can control many features and operations of the device upon which it is installed. For example helper BOT system 3260 can call external services 2250 that interface with functionality and applications on a device via APIs or by other means, to perform functions and operations that might otherwise be initiated using a conventional user interface on the device. Such functions and operations may include, for example, setting an alarm, making a telephone call, sending a text message or email message, adding a calendar event, and the like. Such functions and operations may be performed as add-on functions in the context of a conversational dialog between a user and the helper BOT system by way of the avatar 3300. Such functions and operations can be specified by the user in the context of such a dialog, or they may be automatically performed based on the context of the dialog. One skilled in the art will recognize that the helper BOT system 3260 can thereby be used as a control mechanism for initiating and controlling various operations on the electronic device, which may be used as an alternative to conventional mechanisms such as buttons or GUIs.

For example, the user may provide input to helper BOT system 3400 such as “I need to have some 6^{th} grade level content put together for my son so he can do a report on volcanoes.”

Once the helper BOT system 3400 is engaged and the avatar understands the service request, the helper BOT system 3400 can for example, call the ResearchIT BOT with a call to the YourSearch Web Service and parameters having to do with the son's demographics. YourSearch may either enlist external services or may find a solution in the search transaction database archives of long term memory, retrieve it adapt it and then re-use it. The BOT will then deliver search results suitable for a 6^{th} grader in the form of a neatly formatted notebook consisting of relevant facts, illustrations and/or media elements about volcanoes. The son may take the artifact that his BOT provided and use it to create his report. If the service request is ambiguous or in need of further clarification, the avatar will ask for the request again and request that you speak audibly and clearly. The avatar will also attempt to paraphrase your request so user will understand what the avatar believes is his/her request. Upon proper interpretation of the request, the right combination of BOTs and/or external services 2250 will be invoked. When results are obtained after completing execution of a service request or a stored procedure, they are output to the message bus 3267 and prepared for delivery to the client.

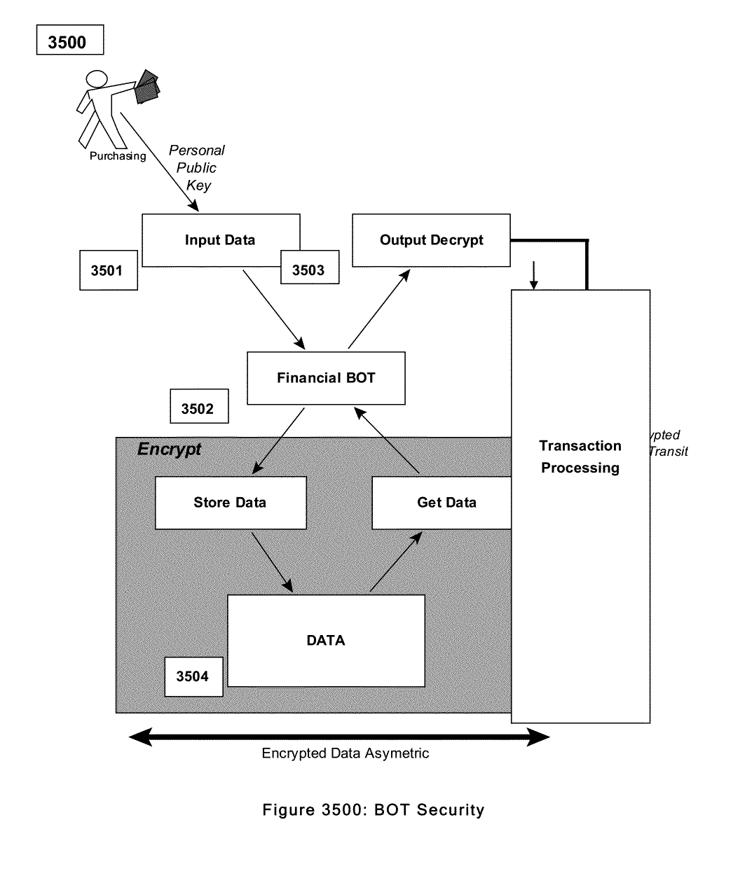

In some embodiments, financial transactions are securely handled by Financial BOTS. Refer to FIG. 3500, there is shown a block diagram depicting a Security Model 3500 suitable for implementing at least a portion of the BOT Security system. The security model adheres to the X.509 ITU-T standard for a public key infrastructure (PKI) and Privilege Management Infrastructure (PMI). The standard fulfills helper BOT Security Requirements in that it provides amongst other things, standard formats for public key certificates, certificate revocation lists, attribute certificates, and a certification path validation algorithm.

In 3501 BOT Security will encrypt a transaction with the transaction requestor's private key and the target transaction service's public key and submit the request to the BOT security service. A smart tunnel is formed between the requesting BOT and the BOT enabled web service. An X.509 mutual encrypted tunnel is established in which the user is required to authenticate the communication channel before being granted access to a TCP-IP connection.

In 3502 upon receipt of the request in this example of BOT Security—Financial BOT will decrypt the message with its trusted service private key and verify that the public key in the message sent matches the public key and account id stored in the database in 3504 for the encrypted request if it matches the decrypted request message will be stored temporarily in memory 3503 and utilized to begin processing of the request and steps in a the requested transaction on behalf of the requestor. After the transaction is complete the temporary memory in 3503 will be destroyed and the results of the transaction returned to the requestor.

A BOT has intrinsic characteristics (What it is, What is can do. Where it lives and Which service it is associated with). An avatar issues a request to BOTs that its owner has subscribed to. The BOT must be given specific (permissions) signed by the owner of the avatar (Entitlements). For example, owner subscribes to BOT service BANKOFAMERICA. BOT service assigned to its avatar as part of the instantiation of this BOT subscription. The owner will first be request to enter their PIN or Fingerprint to show ownership of their x.509 Certificate then the process of entitlements will be started the owner will then set entitlement criterion. The following are examples of Entitlements:
Allowed to transfer up to $1,000 within the us and a certain list of accounts.
Automatic review my accounts activities and notify me if BOT security identifies and fraudulent activity

For data being stored on-behalf of the owner's financial BOT the data will be encrypted with its trusted service private key and its public key on behalf of the transaction owner and stored on storage devices 3440. Part of the data stored for BOT Security includes the rights or Entitlements themselves. Such entitlements are available for add/edit via an interface that is provided to the user by BOT security but which is only available to the user once authenticated and working within a secure environment.

BOT Security Entitlements can refer to right to access restrictions upon users with regard to what data or functions they access and/or what they want to protect, where they may want to have the protection applied, and/or when this protection begins. Entitlements may also apply to the pieces of information themselves with respect to the level of security that is applied to that piece of information. Each user will require authentication even to gain access to their personal avatar.

In at least one embodiment, BOTs are called and after execution of their script, deliver results that represent input to another BOT that is then called afterwards. This loop can go on for as long as necessary to execute the main service request and/or stored procedure. In at least one embodiment, BOTs are called and after execution of their script and/or a stored procedure the result array is captured and stored in a storage device for recall at a later time by a similar request for service initiated by either the same or different user. Storage devices can in at least one embodiment, include database tables, but results can also be stored for later recall from short term and long term memory modules internal to 3420.

For one or more of the invention(s) described herein, the following BOT embodiments are described in this patent application, and are presented for illustrative purposes. The described embodiments are not intended to be limiting in any sense. One or more of the BOTs listed here may be widely applicable to numerous embodiments, as is readily apparent from the disclosure. These embodiments are described in sufficient detail to enable those skilled in the art to practice one or more of the BOT invention(s), and it is to be understood that other embodiments may be utilized and that structural, logical, architectural, software, electrical and other changes may be made without departing from the scope of the one or more of these Helper BOT invention(s). Accordingly, those skilled in the art will recognize that the one or more of the following BOT invention(s) may be practiced with various modifications and alterations. It should be clear that features are not limited to usage in the one or more particular BOT embodiments or figures with reference to which they are described. The following disclosure of BOT embodiments discovered to date is neither a literal description of all BOT embodiments, of one or more of the BOT invention(s) nor a listing of features of one or more of the BOT invention(s) that must be present in all BOT embodiments:

The 12 “EmBOTiments”

Millions of helper BOTs will evolve over time for purposes we can't even begin to imagine. As the inventor of the helper BOT, I enthusiastically present the first twelve.

ToDoList

The ToDoList BOT will tell you the things you need to do on any given day. It will maintain your calendar and keep track of everyday activities. It won't require you to interact with a calendar app rather it will just talk to you—sometimes by messaging, other by way of your avatar. It will communicate with other BOTs whom will in turn supply additional action items that have to be done. In so doing, it acts as the technical coordinator that runs the main script and calls to other BOTs for assistance when needed. This BOT will also show items that have been done for you by your BOT team.

Thoughtful

The Thoughtful BOT will know about all the people you care about and their favorite things that they like, their interests, and that which makes them happy.

EventIntel

The EventIntel BOT will know about all significant dates for all the people that you care about—birthdays, anniversaries, Christmas, Mothers day, Fathers day, etc.

BuyIT

The BuyIt BOT will know how to complete a purchase transaction on behalf of one of our clients. It will be able to find and purchase items online like people do. It will know about the dollar limits up to which it may purchase an item as opposed to sending an alert to our client that it has found an item of interest. This BOT will know your financial information and so we will need BOT Security.

ResearchIT

The ResearchIT BOT will know how to search for information about a topic using the web and digital libraries. This BOT will know how to use the features of YOURSearch to ensure that the results it provides will satisfy user preferences.

DocumentIT

The DocumentIT BOT will know how to package and deliver information in a document format and style of interest. This BOT will know about all the different types of documents and deliver information in the form of document products.

Scan&OrganizeIT

The Scan&OrganizeIT BOT will know how to wait for and accept a scanned document, then identify what it is, and file it according to how you have taught it to organize your information.

GroceryList

The GroceryList BOT (or ToBuyList BOT) will remember your “grocery” list (or list of any items you are about to purchase) and allow you to manage it by adding and deleting line items and quantities. It will also know how to go to store web sites and find digital coupons for items you have already committed to purchasing and save you money by delivering them to your smart phone right at the point of sale!

ScheduleIT

The ScheduleIT BOT will monitor your schedule and email and manage your appointments and mail inboxes/outboxes by interacting with you and following guidelines you provide.

ServiceIT

The ServiceIT BOT will know about all your car maintenance schedule, your appliances, your computer hardware, and any purchased goods for which a well kept maintenance schedule ensures a longer life of usefulness for our clients. All of these maintenance schedules will be kept in one place and your ServiceIT BOT will alert you ahead of time either directly by texting you, by way of your personal avatar, or by putting an action item on your to do list by sending a message to the ToDoListBOT.

ExpenseIntel

The ExpenseIntel BOT will give you global access to the data behind all of your monthly expenses. It will know how much you spent each month for gas, heat, electricity, water, and any utility of interest. In addition, it will know and understand the usage statistics and calculations that produce the bills. It will respond to questions about consumption, last 6 month average, month by month comparisons and the like. For example, if our clients want to analyze their bill before and after putting in central air conditioning, this BOT will enable that task to become much easier.

GraphIT

The GraphIT BOT will use the Show Chart Method in the Display Engine to show charts about analyses of interest to our clients. For example, the GraphIT BOT will team up with the ExpenseIntel BOT to produce graphs that depict these analyses. In our last example, where our client wanted to compare the electricity consumption before and after installing central air, the ExpenseIntel BOT will gather the information (from BOT-enabled utility company web sites) and feed it to GraphIT BOT. The GraphIT BOT will in turn process the data on a nice chart with color and the display engine will put it on your big screen TV, smart phone, or laptop/personal computer.

The Next BOT Generation . . . To Date

Beyond the first 12 BOT Embodiments, the following have likewise been discovered:

Social Media Manager BOTs

This BOT will maintain your Facebook, Twitter or any social media page for you.

Medicine Manager BOT

This BOT will help a client remember when to take medicine—and can also help a parent to remember their child's medicine schedule as well.

Email Manager BOT

This BOT will make sure your email is kept clean and that your rules are followed for where you want email classified.

Pet Maintenance BOT

This BOT will help you schedule your water changes for fish tanks, your shots for your puppy, remind you to clean the cage for your bird, etc.

Snippet BOT

This BOT is aware of digital programs inducted into the digital library at the program level, but is also aware of snippets within these digital entities that can be directly indexed and inducted in their own right. For example, there could be a digital library element that is a show about Travel and vacation spots. At the program level, the underlying DL architecture will already serve these to consumers in ranked order by classification or preference. The snippet BOT however, will know the SMPTE code beginning and ending markers for segments within shows so if the Travel program had a segment on Jamaica, snippet BOT will identify this snippet uniquely and pass it to the Librarian in the DL architecture for induction as a library element in its own right. After this, this snippet can be retrieved or served to people looking for information on “Jamaica.”

Market Research BOT

This BOT enables profiles to be formed for searchers based on their search transactions. This BOT identifies opportunities to market BOT products or services to users that are likely to be interested in them.

What is claimed:

1. A personal helper BOT system, capable of interacting with a device, comprising:
a user interface engagable via such device;
means for a user of the system to cause data to be input into the system, wherein such data is made recognizable by such system;
means for storing at least one BOT;
means for coordinating the activity of at least one BOT, wherein such coordinating means
interprets the inputted data for such BOT,
synthesizes a procedure in response to the data,
translates the data following the synthesis into action steps that invoke at least one BOTs,
executes such procedure based upon such translations, and
generates at least one response representative of the work of at least one BOT; and
means for communicating at least one such response to the user via the user interface.

2. The system of claim 1 wherein the data inputting means includes the user interface.

3. The system of claim 1 wherein the data inputted into the system causes the initiation of a search.

4. The system of claim 3 wherein such search prompts the user for information and uses such information as parameters for the search, further wherein such parameters include at least one of the following:
Age
Spoken Language
Knowledge Domain
Reading Level
Age of the document
Preferred Style of Search Result including:
List of Web Links Result
Report Result
Multimedia Report Result
Statistical Result
Graph Result

5. The system of claim 1 wherein data in the system includes the results of a search by BOTs based upon data caused to be inputted by the user previously.

6. The system of claim 1 wherein the BOTs collaborate to create at least a schedule for such user, maintain to-do list for such user, obtain personally interesting information, automate personalized services, perform web site transactions to satisfy goals, leverage external programming application as tools, complete tasks and synthesize useful products and documents for such user.

7. The system of claim 1 wherein elements of the inputted data are stored within the system.

8. The system of claim 3 wherein at least one BOT performs searching functions.

9. The system of claim 3 wherein the system produces a ranked ordering of such responses based in part upon the execution of such procedure and specific inputted data.

10. The system of claim 7 wherein such specific inputted data is such user's profile.

11. The system of claim 1 wherein the system is electronically connectable to an external search engine that process request using various informational elements.

12. The system of claim 1 wherein search functions results generated remotely are part of the inputted data.

13. The system of claim 1 wherein the inputting means further comprises means for authenticating the user's identity prior to the BOTs interpreting the inputted data.

14. The system of claim 13 wherein the inputted data is maintained in the system in a secure fashion.

15. The system of claim 13 wherein in the authenticating means adheres to a standard public key infrastructure.

16. The system of claim 1 wherein the executing of such procedures includes the invocation of at least one BOT that ensure that at least one generated response is secure.

17. The system of claim 1 wherein the device is electronically connected to at least one processor and such processor comprises such storing means, such coordinating means and such communicating means.

18. The system of claim 1 wherein the inputted data includes information from at least one of the following categories:
Demographic Information:
User Name
Optional Password
Date of Birth
City of Birth
Primary phone number
Secondary phone number
Email Address
Street Address
City
State
Zip Code
Country
Emergency Contact Name
Emergency Contact Phone Number
Emergency Contact Email
Financial Information:
Bank Names
Bank Account Numbers
Bank Routing Numbers
Credit Card Types
Credit Card Account Numbers
Credit Card Expiration Dates
Other Payment Method
Other Payment Method Name
Other Payment Method Account Number
Personal information:
Popular social media environments including friend list, family list, and significant other
Popular applications including shopping sites, and search engines
BOT-enabled applications and web sites
Health Information:
Blood Type
Blood Pressure Category as Normal, Borderline, High
Family Health History Information
Known Medical Conditions as Hypertension, Disorders, Diseases, Etc.
Date of most recent hospital or clinic encounter
Description of most recent encounter
Food Allergies as Peanut, Seafood, etc.
Most Recent Pulse with Date/Time
Most Recent Blood Pressure Reading with Date/Time
Entertainment information:
Preferences for how you like to experience entertainment including:
Alone
With Family including members of Family List and Effective Date
With Friends including members of Friend List and Effective Date
With Significant Other as Romantic, Platonic and Effective Date
Preferences for what kinds of things you like to watch including TV shows, Movies:
Drama
Action
Comedy
Other
Preferences for what categories of things the user might like to consume comprising a method for allowing the user to indicate said preferences in ranked order:
Sports events as Boxing, Fishing, Basketball, Etc.
Movies as per specific Movie Preferences as Drama, Comedy Etc.
TV Shows as Home Improvement, Nature, Etc.
Sitcoms as specified by user
Value Preferences indicating on a scale from 1 to 10, the user's willingness to watch programs containing that type of program content.
Sexual Tolerance
Profanity Tolerance
Nudity Tolerance
Violence Tolerance
Educational Content
A value preference indicator that indicates for each value preference if the user is for (1) or against (0) the type of program content.
Security Preferences that enable the user to indicate what data items they would like to protect with Internet security.
Settings information:
Demographic
Health
Financial
Social
Other
Configuration settings:
Amount of time in minutes before an event to be notified about event
Dollar limits set for automatic purchases

19. The system of claim 1 further comprising means for storing the inputted data for at least one user.

20. The system of claim 1 wherein the user can select a least one BOT to be part of a team to be used in the interpretation of the inputted data.

21. The system of claim 20 wherein the selection is the result of a financial transaction.

22. The system of claim 1 wherein at least one response generated by at least one BOT becomes data interpreted by at least one BOT and at least one other response is generated.

23. The system of claim 1 wherein the communicating means customizes at least one response based in part upon specific data.

24. The system of claim 1 wherein such BOTs learn to do a task autonomously after learning from prior use of the system.

25. The system of claim 1 wherein the system further comprises a digital library architecture, user directed search filter, and BOT security architectures.

27. The system of claim 1 wherein the system may be configured and programmed to provide different types of operations, functionalities, features, applications and products, and to combine a plurality of features, operations, functionalities, applications, or reusable programs.

28. The system of claim 1 wherein the system can actively elicit service requests from a user, interpret user directives, disambiguate among competing directives, request and receive clarifying directives or canceling directives as needed, and carry out or initiate service requests based on the understanding of the directive.

29. The system of claim 1 wherein the system is interoperable with external functionality via remote procedure calls, utilization of API's, and other suitable mechanism.

30. The system of claim 29 wherein such interoperability is performed via at least one invoked BOT.

31. The system of claim 1 wherein the synthesis of the procedure can be captured and replicated when appropriate in connection with data provided at a later point in time.

32. The system of claim 1 wherein the synthesis uses a previously captured procedure modified based upon new data.

33. The system of claim 1 wherein the system is interoperable with external BOTs.

34. The system of claim 1 wherein the intelligence encapsulated by at least one BOT will involve deep knowledge and understanding of software use case functionality.

35. The system of claim 1 wherein the user interface further comprises a personal assistant in the form of a customizable avatar.

36. The system of claim 35 wherein the inputting means is capable of receiving sound.

37. The system of claim 35 wherein inputting means is capable of receiving touch input.

38. The system of claim 35 wherein such user interface device comprise graphical interface elements.

39. The system of claim 1 wherein the device includes a video displaying monitor.

40. The system of claim 1 wherein the system employs external software in order to respond to the inputted data.

41. The system of claim 1 wherein the interpreting of the data is supported by at least one application programming interface (API).

42. The system of claim 1 in which the BOTs storing means comprises of a library of searchable elements of possible interest to at least one user, wherein such elements can be ranked within categories according to the likelihood that at least one user will find at least one element of interest.

43. The system of claim 1 wherein the communication means can transmit such response to the user interface in ay least one of the following forms:
a list of web links to web sites containing information about the search keywords.
a report where the searched for content is extracted from web sites of interest and composed into a document and is returned to the searcher
a multi-media report where the report comprises pictures and video in addition to text
summaries of the search topic by counting, quantifying and composing statistical results about the search topic
graphics showing such analytical and statistical summaries about the search topic.

44. The system of claim 17 wherein the processor incorporates multithreading whereby the lines of the code executable by at least one BOT when invoked are loaded into the stack of the thread to which such BOT is assigned.

45. The system of claim 35 where the speech input can be obtained via a conversational user interface.

46. The system of claim 35 wherein the responses are communicated through the use of speech balloons and the avatar uses touch sensitive regions on a video-displaying device with words contained in the balloons to represent options that are presented to the user such that the user can specify additional input.

47. The system of claim 35, wherein avatar responses to user input reflect human emotion.

48. The system of claim 47 wherein the system
stores a repository of responses that reflect human emotions and such emotions are displayed through sequences of such avatar's facial and head motions, gesticulations and coordinated speech,
has electronic access to an object oriented software representation where situational contexts can be grouped into classes that determine the emotional responses,
employs a speech interpreter that looks for keywords in the user's inputs that in turn describe and classify the situational context and thereby invokes the appropriate class of emotional responses, and
use such object oriented representation when general situational contexts are classified, each instance of a class requiring the same stored sequence of avatar responses which is retrieved from the repository and presented to the user.

49. The system of claim 1 wherein
the BOTs call programming code through application programming interfaces (APIs) that enable separate applications to provide outputs in response to inputs provided by BOTs such that the programming code is then able to take part in a transaction with a BOT,
a markup language structure that contains the inputs and the values that the BOT is supplying to the application make up the first part of the transaction,
at least one API processing such markup language structure supports inputs supplied to the application which in turn processes these inputs to produce a set of outputs,
such markup language structure also contains such outputs and output values that the application returns to the BOT making up the last part of the transaction, and
at least one BOT accepts such outputs and returns them as the completion of one of the steps in the BOT's built in script.

50. A personal helper BOT system, capable of interacting with a video displaying device and interoperable with external functionality via remote procedure calls, utilization of API's, and other suitable mechanism, comprising:
a user interface comprising a personal assistant in the form of a customizable avatar, wherein such user interface is engagable via such device;
means for a user of the system to cause data to be input into the system, wherein such data is made recognizable by such system;
means for authenticating the user's identity;
means for such system to receive the results of a search by at least one BOTs based upon data caused to be inputted by the user previously;
means of storing inputted data and search results within the system;
means for storing a team of autonomous helper BOTs;
means for coordinating the activity of such BOTs, wherein such coordinating means
interprets the inputted data for such BOTs,
synthesizes a procedure in response to the data,
translates the data following the synthesis into action steps that invoke the appropriate BOT team members,
executes such procedure based upon such translations, and
generates at least one response representative of the work of the appropriate BOT team members; and
means for communicating at least one such response to the user via the user interface, wherein at least one BOT is invoked to ensure that at least one generated response is secure and at least one such response is customized based in part upon specific data.

51. A method of providing information responsive to a user's inputted data comprising the steps of:
receiving such data through a user interface engagable via a device;
converting such data into a form recognizable by at least one BOT;
coordinating the activity of at least one such BOTs, wherein such coordination includes the steps of
interpreting such data by at least one such BOT,
synthesizing at least one procedure in response to such data,
translating such data following the synthesis into action steps that invoke at least one BOT,
executing such procedure based upon such translations, and
generating at least one response representative of the work of at least one BOT; and
communicating at least one such response to the user via the user interface.
